(19) United States
(12) Patent Application Publication
(10) Pub. No.: US 2018/0144893 A1
(43) Pub. Date: May 24, 2018

(54) ELECTROMAGNETIC CONTACTOR

(71) Applicant: FUJI ELECTRIC FA COMPONENTS & SYSTEMS CO., LTD., Tokyo (JP)

(72) Inventors: Koujun Konishi, Kounosu (JP); Kouetsu Takaya, Kounosu (JP); Hideo Adachi, Fukaya (JP); Yasuhiro Naka, Kitamoto (JP); Yuki Tashima, Kitamoto (JP)

(73) Assignee: FUJI ELECTRIC FA COMPONENTS & SYSTEMS CO., LTD., Tokyo (JP)

(21) Appl. No.: 15/876,271

(22) Filed: Jan. 22, 2018

Related U.S. Application Data
(63) Continuation of application No. PCT/JP2017/006610, filed on Feb. 22, 2017.

(30) Foreign Application Priority Data
Mar. 10, 2016 (JP) 2016-047358

(51) Int. Cl. H01H 50/04; H01H 50/54; H01H 50/36

(52) U.S. Cl. CPC H01H 50/04; H01H 50/541; H01H 2205/002; H01H 2235/01; H01H 50/36

(57) ABSTRACT

To provide an electromagnetic contactor that allows the extension space for arcs to be enlarged without having to enlarge the size in a direction in which a main contact mechanism housing chamber and an auxiliary contact mechanism housing chamber are arranged. An electromagnetic contactor includes a partitioning wall for partitioning a main contact mechanism housing chamber and an auxiliary contact mechanism housing chamber. The partitioning wall has a pair of arc extension recesses that is formed by indenting the partitioning wall toward the side of the auxiliary contact mechanism housing chamber.

### CROSS REFERENCE TO RELATED APPLICATIONS AND INCORPORATION BY REFERENCE

This application is a continuation application filed under 35 U.S.C. § 111 (a) of International Patent Application No. PCT/JP2017/006610, filed Feb. 22, 2017, which claims the foreign priority benefit under 35 U.S.C. § 119 of Japanese Patent Application No. 2016-047358, filed Mar. 10, 2016, the contents of which are incorporated herein by reference.

### TECHNICAL FIELD

The present invention relates to an electromagnetic contactor for opening and closing a current path.

### BACKGROUND ART

Electromagnetic contactors, which open and close a current path, often include a main contact mechanism that carries and interrupts high currents, as well as, an auxiliary contact mechanism that operates in coordination with the operation of the main contact mechanism. For example, an electromagnetic contactor that includes a main contact mechanism and an auxiliary contact mechanism as the one described in PTL 1 is known.

The electromagnetic contactor described in PTL 1 includes: a main contact mechanism that has a pair of main contact side fixed contacts and a main contact side movable contact that can move toward and away from the main contact side fixed contacts; an auxiliary contact mechanism that operates in coordination with the main contact side movable contact; and an electromagnet unit that drives the main contact side movable contact of the main contact mechanism. The electromagnet unit includes a movable plunger that is connected to the main contact side movable contact via a connecting shaft and an excitation coil that excites and generates exciting power in the electromagnet unit to drive the movable plunger.

The main contact mechanism, the auxiliary contact mechanism, and the movable plunger and the connecting shaft of the electromagnet unit, are hermetically sealed in a housing chamber. The housing chamber is filled with arc extinguishing gas.

### CITATION LIST

### Patent Literature

PTL 1: U.S. Pat. No. 7,944,333 B2

### SUMMARY OF INVENTION

### Technical Problem

With such an electromagnetic contactor that includes a main contact mechanism and an auxiliary contact mechanism as described in PTL 1, a main contact mechanism housing chamber that houses the main contact mechanism and an auxiliary contact mechanism housing chamber that houses the auxiliary contact mechanism are partitioned by a partitioning wall made of an insulating material, whereby arcs generated by the main contact mechanism are extinguished within the main contact mechanism housing chamber. This is to prevent arcs generated by the main contact mechanism from adversely affecting the auxiliary contact mechanism.

Here, it is preferable to enlarge the main contact mechanism housing chamber to extend longer and properly extinguish the arcs generated by the main contact mechanism. For example, if a current that flows in the main contact mechanism is large, a small-sized main contact mechanism housing chamber cannot properly block arcs since there is not much space for extending arcs.

On the other hand, if the size of the main contact mechanism housing chamber is enlarged, the size becomes large in a direction in which the main contact mechanism housing chamber and auxiliary contact mechanism housing chamber are arranged, to increase the size of the product.

The present invention is, therefore, made to solve this problem in the prior art. The objective of the present invention is to provide an electromagnetic contactor that allows the extension space for arcs to be enlarged without having to enlarge the size in a direction in which a main contact mechanism housing chamber and an auxiliary contact mechanism housing chamber are arranged.

### Solution to Problem

In order to achieve the object mentioned above, according to an aspect of the present invention, there is provided an electromagnetic contactor including: a main contact mechanism housing chamber for housing a main contact mechanism, the main contact mechanism including a pair of main contact side fixed contacts with a predetermined interspace, and a main contact side movable contact configured to move toward and away from the pair of main contact side fixed contacts; an auxiliary contact mechanism housing chamber for housing an auxiliary contact mechanism, the auxiliary contact mechanism including at least a pair of auxiliary contact side fixed contacts that is fixed to an auxiliary fixed contact supporting member, and an auxiliary contact side movable contact configured to move toward and away from the at least pair of auxiliary contact side fixed contacts; an electromagnet unit including a movable plunger for driving the main contact side movable contact and the auxiliary contact side movable contact; and a partitioning wall for partitioning the main contact mechanism housing chamber and the auxiliary contact mechanism housing chamber, wherein the partitioning wall has a pair of arc extension recesses that is formed by indenting the partitioning wall toward the side of the auxiliary contact mechanism housing chamber and into which an arc generated by the main contact mechanism extends.

### Advantageous Effects of Invention

According to the present invention, it is possible to provide an electromagnetic contactor that allows the extension space for arcs to be enlarged without having to enlarge the size in a direction in which a main contact mechanism housing chamber and an auxiliary contact mechanism housing chamber are arranged.

### BRIEF DESCRIPTION OF DRAWINGS

FIG. 1 is a section view illustrative of an electromagnetic contactor according to a first embodiment of the present invention;

FIG. 2 is a section view taken along a line 2-2 of FIG. 1;

FIG. 3 is an exploded perspective view of the electromagnetic contactor illustrated in FIG. 1;

FIGS. 4A and 4B illustrate an arc-extinguishing chamber of the electromagnetic contactor illustrated in FIG. 1; FIG. 4A is a perspective view obliquely from above and FIG. 4B is a perspective view obliquely from below;

FIG. 5 is a section view illustrative of a state where the main contact mechanism and the auxiliary contact mechanism are closed in the electromagnetic contactor illustrated in FIG. 1;

FIG. 6 is a perspective view illustrative of an assembly state of the arc-extinguishing chamber, the main contact mechanism, and the auxiliary fixed contact supporting member of the electromagnetic contactor illustrated in FIG. 1;

FIG. 7 is a section view taken along a line 7-7 of FIG. 6, illustrative of the direction of lines of magnetic force and the directions of the flows of arcs;

FIG. 8 is a section view taken along a line 8-8 of FIG. 7, illustrative of the directions of the flows of arcs;

FIG. 9 is a section view taken along a line 9-9 of FIG. 7, illustrative of the directions of the flows of arcs;

FIG. 10 is a section view illustrative of an electromagnetic contactor according to a second embodiment of the present invention;

FIG. 11 is a section view taken along a line 11-11 of FIG. 10;

FIG. 12 is an exploded perspective view of the electromagnetic contactor illustrated in FIG. 10;

FIGS. 13A and 13B illustrate an arc-extinguishing chamber of the electromagnetic contactor illustrated in FIG. 10; FIG. 13A is a perspective view obliquely from above and FIG. 13B is a perspective view obliquely from below;

FIG. 14 is a section view illustrative of a state where the main contact mechanism and the auxiliary contact mechanism are closed in the electromagnetic contactor illustrated in FIG. 10;

FIG. 15 is a perspective view illustrative of an assembly state of the arc-extinguishing chamber, the main contact mechanism, and the auxiliary fixed contact supporting member of the electromagnetic contactor illustrated in FIG. 10;

FIG. 16 is a section view taken along a line 16-16 of FIG. 15, illustrative of the directions of lines of magnetic force and the directions of the flows of arcs;

FIG. 17 is a section view taken along a line 17-17 of FIG. 16, illustrative of the direction of the flow of an arc;

FIG. 18 is a section view, like FIG. 16, illustrative of a first example where the arrangement of permanent magnets is changed in the electromagnetic contactor illustrated in FIG. 10, also illustrating the direction of lines of magnetic force and the directions of the flows of arcs;

FIG. 19 is a section view taken along a line 19-19 of FIG. 18, illustrative of the directions of the flows of arcs;

FIG. 20 is a section view, like FIG. 16, illustrative of a second example where the arrangement of permanent magnets is changed in the electromagnetic contactor illustrated in FIG. 10, also illustrating the direction of lines of magnetic force and the directions of the flows of arcs;

FIG. 21 is a section view taken along a line 21-21 of FIG. 20, illustrative of the direction of the flow of an arc;

FIG. 22 is a perspective view separately illustrating the main contact side movable contact, the arc-extinguishing chamber, and the auxiliary contact mechanism, which is a variation of the electromagnetic contactor illustrated in FIG. 10; and

FIGS. 23A to 23D illustrate an auxiliary contact mechanism in the variation of the electromagnetic contactor illustrated in FIG. 22; FIG. 23A is a perspective view, FIG. 23B a plan view, FIG. 23C a front view, and FIG. 23D a right side view.

### DESCRIPTION OF EMBODIMENTS

The following will describe the embodiments of the present invention with reference to the drawings.

### First Embodiment

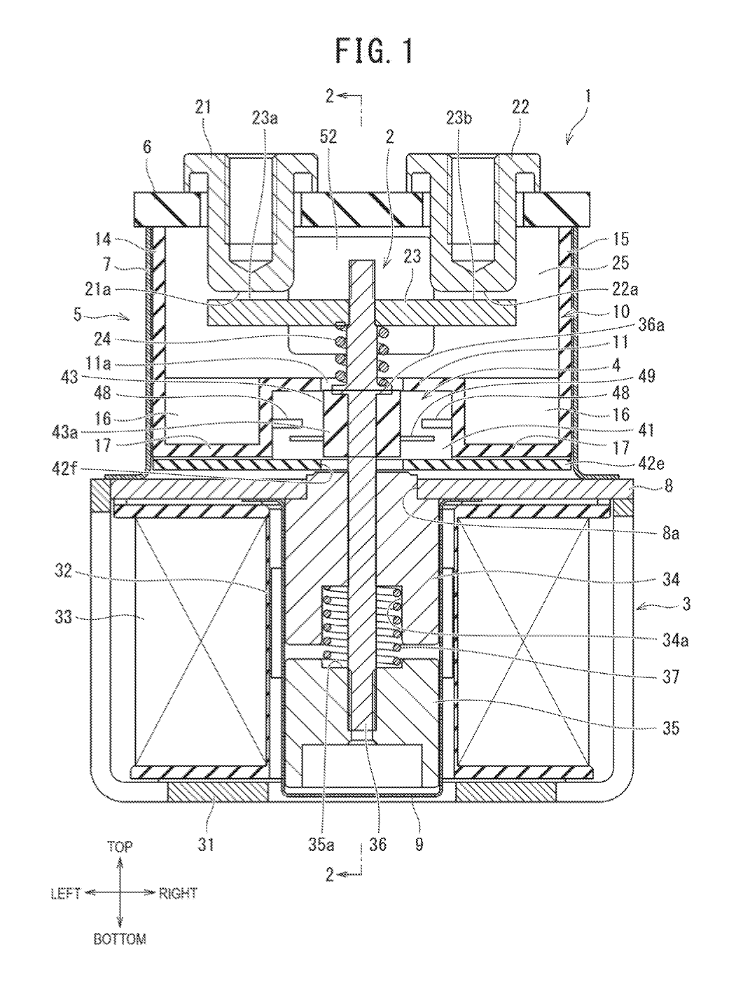

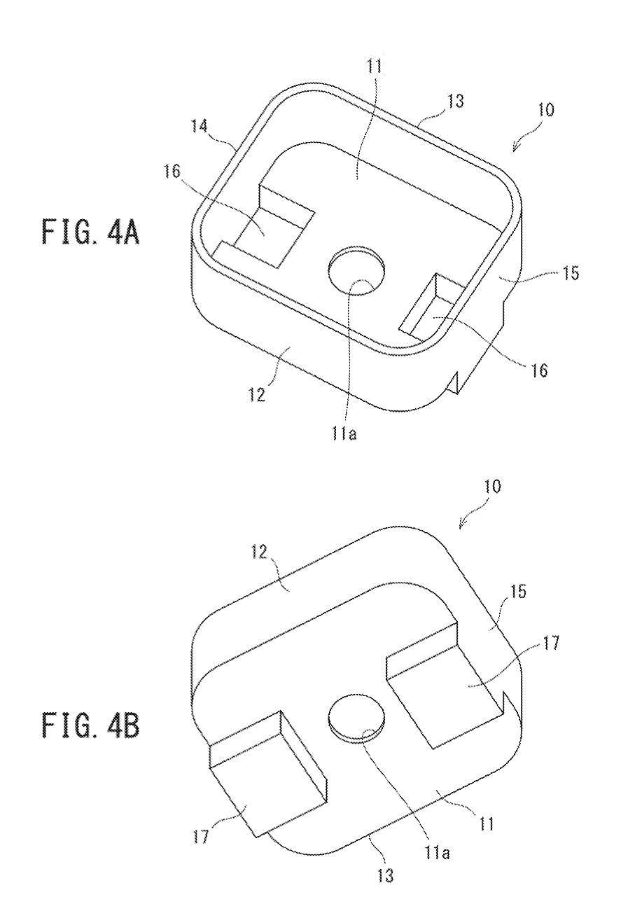

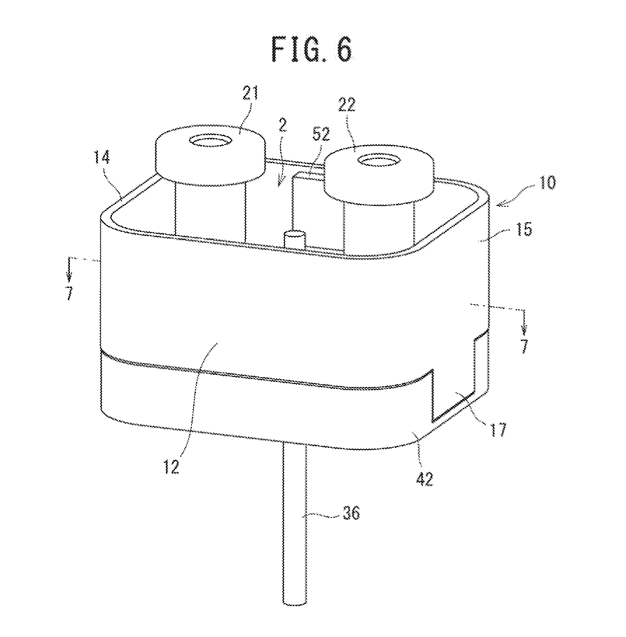

The electromagnetic contactor according to the first embodiment of the present invention is illustrated in FIGS. 1 to 9. The electromagnetic contactor 1 illustrated in FIG. 1 is for opening and closing a current path, including: a main contact mechanism 2; an electromagnet unit 3 configured to drive a main contact side movable contact 23 of the main contact mechanism 2, as will be described later; an auxiliary contact mechanism 4 that operates in coordination with the main contact side movable contact 23; and a housing chamber 5.

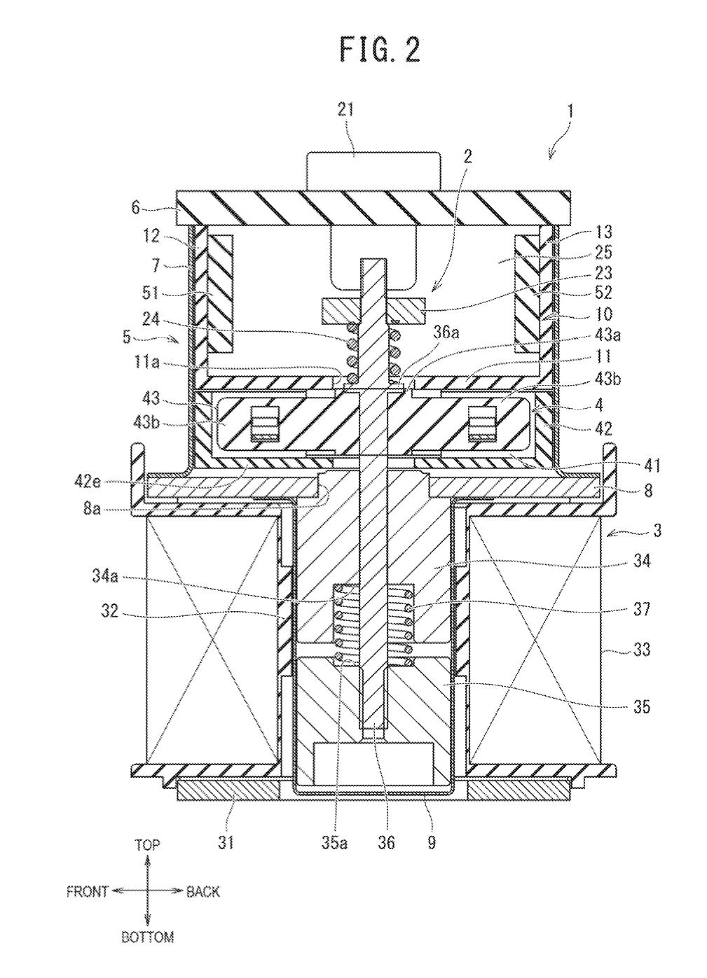

The housing chamber 5 includes: a metal joint member 7 of a rectangular cylindrical shape; a ceramic top plate 6 that is connected to the upper end portion of the joint member 7 and closes the top side of the joint member 7; a magnetic yoke 8 of a flat plate shape, as will be described later, of which upper surface is sealed on the bottom end portion of the joint member 7; and a metal cap 9 of a cylindrical shape that is sealed on the lower surface of the magnetic yoke 8. Then, the housing chamber 5 hermetically houses the main contact mechanism 2, the auxiliary contact mechanism 4, a connecting shaft 36 as will be described later, a fixed iron core 34, and a movable plunger 35, then, is filled with arc extinguishing gas. Hereinafter, in this specification, as indicated by arrows in FIGS. 1 and 2, the top side in FIG. 1 is defined as “top,” the bottom side “bottom,” the left side “left,” and the right side “right,” and the left side in FIG. 2 is defined as “front” and the right side “back.”

Here, the main contact mechanism 2 includes a pair of main contact side fixed contacts 21, 22 fixed to the top plate 6 and a main contact side movable contact 23 that can move toward and away from the pair of main contact side fixed contacts 21, 22. The main contact side fixed contacts 21, 22, made of a conductive metal material, are fixed in a left and right direction on the top plate 6 of the housing chamber 5 with a predetermined interspace therebetween. A contact point 21a is formed on the bottom surface of the left-side main contact side fixed contact 21 and a contact point 22a is formed on the bottom surface of the right-side main contact side fixed contact 22.

The main contact side movable contact 23 is a conductive plate, made of a conductive metal material, that is elongated in a left and right direction and supported by the connecting shaft 36 fixed to the movable plunger 35 of the electromagnet unit 3, as will be described later, in a manner movable in an up and down direction. On the upper surface of the main contact side movable contact 23, a contact point 23a for contacting with the contact point 21a of the left-side main contact side fixed contact 21 is formed on the left end, whereas, a contact point 23b for contacting with the contact point 22a of the right-side main contact side fixed contact 22 is formed on the right end. Then, the connecting shaft 36 has a flange part 36a below the main contact side movable contact 23, the flange part being protruded outwardly. A contact spring 24 is further provided between the flange part 36a and the main contact side movable contact 23 to upwardly bias the main contact side movable contact 23.

This main contact mechanism 2 is housed in a main contact mechanism housing chamber 25 in the housing chamber 5. Inside the main contact mechanism housing chamber 25 is arranged an arc-extinguishing chamber 10 made of an insulating material. As illustrated in FIGS. 1 to 4B, the arc-extinguishing chamber 10 includes a partitioning wall 11 of a generally rectangular flat plate shape that separates the auxiliary contact mechanism 4 from the main contact mechanism 2 and forms an auxiliary contact mechanism housing chamber 41 below the partitioning wall 11. Thus, the partitioning wall 11 of the arc-extinguishing chamber 10 partitions the main contact mechanism housing chamber 25 and the auxiliary contact mechanism housing chamber 41. The arc-extinguishing chamber 10 has a front wall 12 that rises from the front edge of the partitioning wall 11; a rear wall 13 that rises from the rear edge of the partitioning wall 11; a left side wall 14 that rises from the left edge of the partitioning wall 11; and a right side wall 15 that rises from the right edge of the partitioning wall 11. The front wall 12 is connected to the front edges of the left side wall 14 and the right side wall 15 and the rear wall 13 is connected to the rear edges of the left side wall 14 and the right side wall 15 in such a manner as to enclose the arc-extinguishing chamber 10. Then, as illustrated in FIGS. 1 and 2, the front wall 12, the rear wall 13, the left side wall 14 and the right side wall 15 of the arc-extinguishing chamber 10 are formed in a dimension inscribed in the inner circumferential surface of the joint member 7, and the front wall 12, the rear wall 13, the left side wall 14 and the right side wall 15 surround and house there inside the main contact mechanism 2. The partitioning wall 11 has a through hole 11a at the central part, through which the connecting shaft 36 can be inserted.

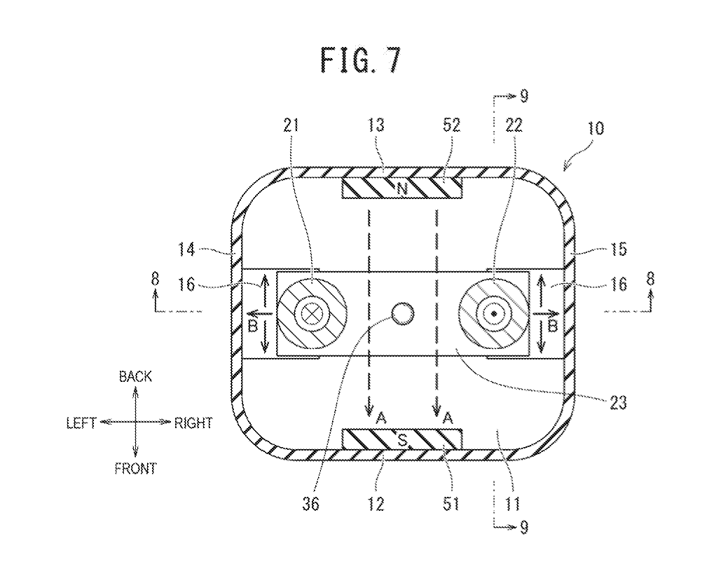

The partitioning wall 11 of the arc-extinguishing chamber 10 has a pair of left and right arc extension recesses 16, into which arcs generated by the main contact mechanism 2 are extended, with the recess being formed by indenting the partitioning wall 11 toward the side of the auxiliary contact mechanism housing chamber 41. The left-side arc extension recess 16 is formed, as illustrated in FIG. 1, near the contact point 23a of the main contact side movable contact 23 and the contact point 21a of the main contact side fixed contact 21, specifically, below the contact points 23a and 21a. The right-side arc extension recess 16 is formed, as illustrated in FIG. 1, near the contact point 23b of the main contact side movable contact 23 and the contact point 22a of the main contact side fixed contact 22, specifically, below the contact points 23b and 22a. A pair of arc extension recess forming projections 17 is provided to form the pair of left and right arc extension recesses 16. The left-side arc extension recess 16 extends in a left and right direction from a position in the vicinity of the contact point 23a up to the left side wall 14 of the arc-extinguishing chamber 10 and the right-side arc extension recess 16 extends in a left and right direction from a position in the vicinity of the contact point 23b up to the right side wall 15 of the arc-extinguishing chamber 10. The width of each arc extension recess 16 in a front and rear direction is, as illustrated in FIG. 7, slightly larger than the width of the main contact side movable contact 23 in a front and rear direction. The function of each arc extension recess 16 will be described later in detail.

The auxiliary contact mechanism 4 is housed in the auxiliary contact mechanism housing chamber 41 and has a plurality of pairs (two pairs, in the first embodiment) of auxiliary contact side fixed contacts 48, 48 and a plurality (two, in the first embodiment) of auxiliary contact side movable contacts 49 that can move toward and away from the plurality of pairs of auxiliary contact side fixed contacts 48, 48. This auxiliary contact mechanism 4 is used, among others, to detect the open/closed state of the main contact mechanism 2 and to detect whether the main contact side movable contact 23 is welded to the main contact side fixed contacts 21, 22 in the main contact mechanism 2.

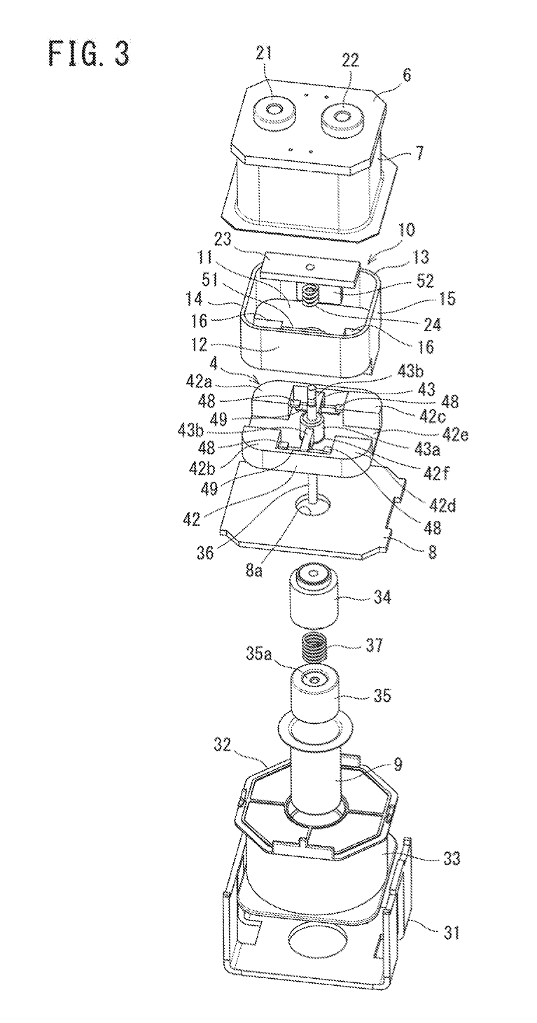

Here, the plurality of pairs of auxiliary contact side fixed contacts 48, 48 are fixed to an electrically non-conductive auxiliary fixed contact supporting member 42. As illustrated in FIG. 3, this auxiliary fixed contact supporting member 42 has four auxiliary fixed contact supporting parts 42a, 42b, 42c, 42d that are housed in the auxiliary contact mechanism housing chamber 41 at both front and rear sides of and between the pair of arc extension recesses 16 and that fix the plurality of pairs of auxiliary contact side fixed contacts 48, 48. These four auxiliary fixed contact supporting parts 42a, 42b, 42c, 42d are installed on a bottom plate part 42e of a generally rectangular flat plate shape. The auxiliary fixed contact supporting member 42 is integrally formed by molding electrically non-conductive synthetic resin. It should be noted that the bottom plate part 42e has a through hole 42f, through which the connecting shaft 36 can be inserted.

The plurality of auxiliary contact side movable contacts 49 are supported by an auxiliary movable contact supporting member 43. As illustrated in FIG. 3, the auxiliary movable contact supporting member 43 includes a cylindrical-shape center part 43a fixed to the connecting shaft 36 and a pair of auxiliary movable contact supporting parts 43b, 43b, extending forward and backward from the center part 43a. The auxiliary movable contact supporting member 43 is housed in a left and right direction in the auxiliary contact mechanism housing chamber 41 between the pair of arc extension recesses 16. The plurality of auxiliary contact side movable contacts 49 extend, as illustrated in FIG. 3, in the same left and right direction as the main contact side movable contact 23 and are supported by the pair of auxiliary movable contact supporting parts 43b, 43b. Each auxiliary contact side movable contact 49 is supported by each auxiliary movable contact supporting part 43b, 43b in such a manner that the contact is always upwardly biased by a biasing spring, which is not illustrated. In the case of the electromagnetic contactor 1 of the first embodiment, the auxiliary contact side movable contact 49 supported by the front-side auxiliary movable contact supporting part 43b extends in the same left and right direction as the main contact side movable contact 23 and contacts with an auxiliary contact side fixed contact 48 fixed to the auxiliary fixed contact supporting part 42b and an auxiliary contact side fixed contact 48 fixed to the auxiliary fixed contact supporting part 42d that is opposed in a left and right direction to the auxiliary fixed contact supporting part 42b. Whereas, the auxiliary contact side movable contact 49 supported by the rear-side auxiliary movable contact supporting part 43b extends in the same left and right direction as the main contact side movable contact 23 and contacts with an auxiliary contact side fixed contact 48 fixed to the auxiliary fixed contact supporting part 42a and an auxiliary contact side fixed contact 48 fixed to the auxiliary fixed contact supporting part 42c that is opposed in a left and right direction to the auxiliary fixed contact supporting part 42a.

Here, each pair of auxiliary contact side fixed contacts 48, 48 and each auxiliary contact side movable contact 49 form a-contact (i.e., normally open-type contact), thus, when the main contact side movable contact 23 is in a released state, the contact portions formed at both ends of the auxiliary contact side movable contact 49 are apart from the contact portions of the pair of auxiliary contact side fixed contacts 48, 48 while the auxiliary contact side movable contact 49 maintaining a predetermined interspace therebelow. Whereas, when the main contact side movable contact 23 becomes in a charged state, the auxiliary contact side movable contact 49 moves upward and the contact portions formed at both ends of the auxiliary contact side movable contact 49 contact with the contact portions of the pair of auxiliary contact side fixed contacts 48, 48 by a predetermined contacting force of the biasing spring.

It should be noted that each pair of auxiliary contact side fixed contacts 48, 48 and each auxiliary contact side movable contact 49 may form b-contact (i.e., normally closed-type contact). Alternatively, the front-side auxiliary contact side fixed contacts 48, 48 and the front-side auxiliary contact side movable contact 49 may form a-contact and the rear-side auxiliary contact side fixed contacts 48, 48 and the rear-side auxiliary contact side movable contact 49 may form b-contact.

Next, as illustrated in FIGS. 1 to 3, the electromagnet unit 3 includes a lower magnetic yoke 31 that is U-shaped when seen from a side. The upper end, which is an open end, of the lower magnetic yoke 31 is fixed to a magnetic yoke 8 of a flat plate shape, the upper surface of which is sealed on the bottom end portion of the above-described connecting member 7. The magnetic yoke 8 has a through hole 8a at the central part.

Further, the central part of the lower surface of the magnetic yoke 8 is sealed on a cap 9 of a bottomed cylinder-shape to surround the through hole 8a.

Inside this cap 9, a fixed iron core 34 of a column shape that is fixed to the through hole 8a of the magnetic yoke 8 is arranged, as well as, a movable plunger 35 is arranged below the fixed iron core 34 in a manner movable in an up and down direction. The connecting shaft 36 supports the main contact side movable contact 23 at the upper end side, is inserted through a through hole formed at the center of the fixed iron core 34 and is fixed to the movable plunger 35 of a column shape at the lower end.

The fixed iron core 34 has a return spring housing recess 34a that is indented upwardly from the lower surface. Also, the movable plunger 35 has a return spring recess 35a that is indented downwardly from the upper surface. Between the return spring housing recess 34a and the return spring recess 35a is housed a return spring 37 that always downwardly biases the movable plunger 35.

Further, a spool 32 is arranged at the outer periphery of the cap 9. This spool 32 is wound, at the outer periphery, by an excitation coil 33 configured to drive the movable plunger 35.

Further, a pair of arc-driving permanent magnets 51, 52 for driving arcs in the extension directions of the main contact side movable contact 23 (leftward and rightward directions) is oppositely arranged on the front wall 12 and rear wall 13 of the arc-extinguishing chamber 10, as illustrated in FIGS. 1 to 3, 6 and 7.

The following will describe the operation of the electromagnetic contactor 1 of the first embodiment.

Suppose one main contact side fixed contact 21 is connected to a power supply source that supplies a large current and the other main contact side fixed contact 22 is connected to a load device.

In this condition, as illustrated in FIG. 1, it is assumed that an excitation coil 33 of the electromagnet unit 3 is in an unexcited state and the main contact side movable contact 23 is in a released state where the electromagnet unit 3 is not generating an exciting force that raises the movable plunger 35.

In this released state, the movable plunger 35 is downwardly biased by the return spring 37. As such, the main contact side movable contact 23 of the main contact mechanism 2, which is connected to the movable plunger 35 via the connecting shaft 36, is apart from the pair of main contact side fixed contacts 21, 22 with a predetermined interspace. In this way, the electric current path between the pair of main contact side fixed contacts 21, 22 is in an interrupted state and the main contact mechanism 2 is in an open state.

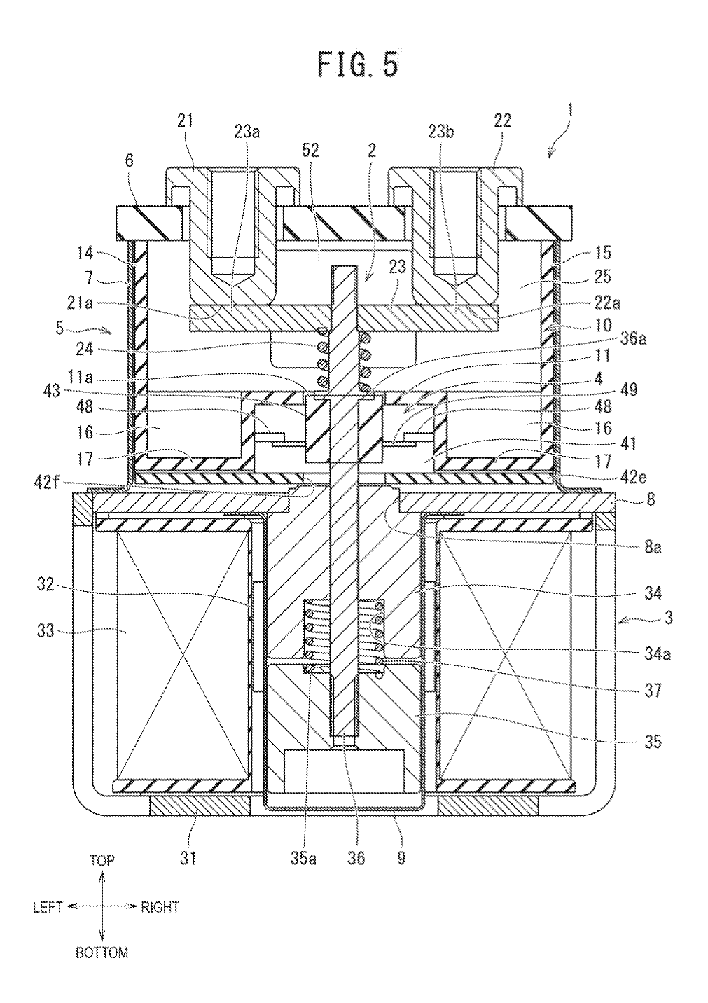

From this released state, if electricity is carried to the excitation coil 33 of the electromagnet unit 3, an exciting force is generated by the electromagnet unit 3, as illustrated in FIG. 5, raising the movable plunger 35 upward against the biasing force of the return spring 37.

In this way, with the rise of the movable plunger 35, the main contact side movable contact 23 that is connected to the movable plunger 35 via the connecting shaft 36 is also raised, whereby both contact points 23a, 23b of the main contact side movable contact 23 contact with both contact points 21a, 22a of the pair of main contact side fixed contacts 21, 22 by the contact force of the contact spring 24.

As the result, a large current from the power supply source is supplied to the load device through the one main contact side fixed contact 21, the main contact side movable contact 23, and the other main contact side fixed contact 22, and the main contact mechanism 2 becomes in a closed state.

When the main contact mechanism 2 is shifted from the open state to the closed state, each auxiliary contact side movable contact 49 of the auxiliary contact mechanism 4 contacts with a corresponding pair of auxiliary contact side fixed contacts 48, 48, through which a current flows.

Then, to interrupt the current feed to the load device when the main contact mechanism 2 is in the closed state, electricity to the excitation coil 33 of the electromagnet unit 3 is turned off.

When the electricity to the excitation coil 33 is turned off, the electromagnet unit 3 loses the exciting force for moving the movable plunger 35 upward and the movable plunger 35 falls by the biasing force of the return spring 37.

This fall of the movable plunger 35 causes a fall of the main contact side movable contact 23 that is connected to the movable plunger 35 through the connecting shaft 36. If the contact spring 24 is exerting a contact pressure against this fall, the main contact side movable contact 23 stays in contact with the pair of main contact side fixed contacts 21, 22. Thereafter, when the contact pressure of the contact spring 24 is lost, the closed state shifts to an open start state where the main contact side movable contact 23 moves downward apart from the pair of main contact side fixed contacts 21, 22.

In such an open start state, arcs are generated between both contact points 23a, 23b of the main contact side movable contact 23 and both contact points 21a, 22a of the pair of main contact side fixed contacts 21, 22, thus, an electricity conducting state is maintained by the arcs.

The arcs are extinguished as follows.

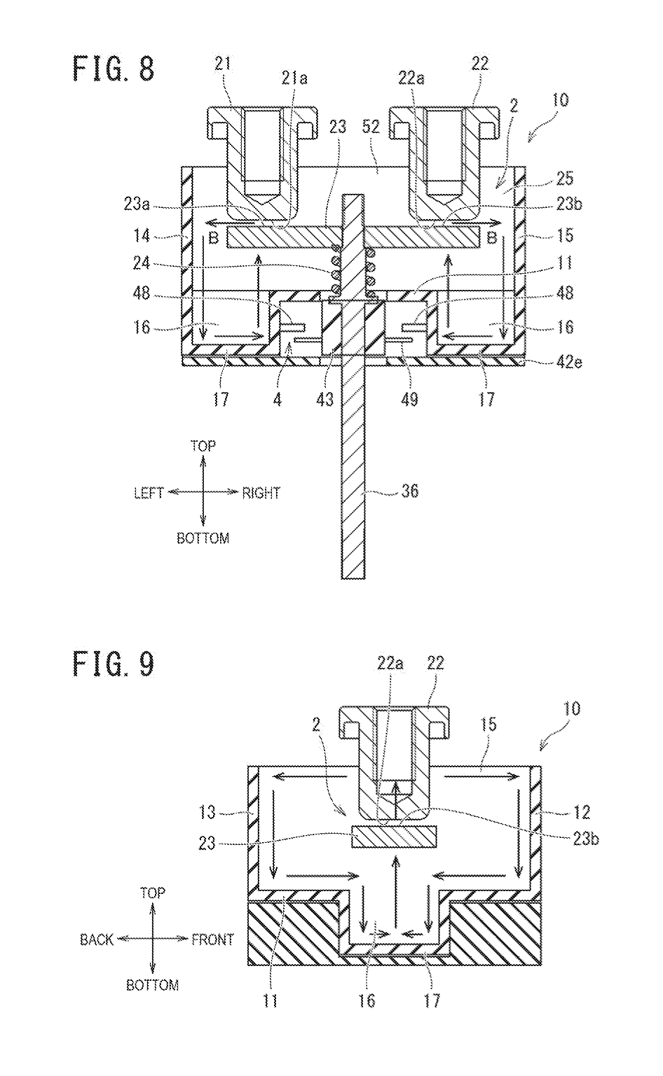

As illustrated in FIG. 7, a pair of arc-driving permanent magnets 51, 52 for driving arcs in the extension directions of the main contact side movable contact 23 (leftward and rightward directions) is oppositely arranged on the front wall 12 and rear wall 13 of the arc-extinguishing chamber 10. The lines of magnetic force are directed in a direction indicated by dashed line arrows A from the N pole of the arc-driving permanent magnet 52 located on the rear wall 13 to the S pole of the arc-driving permanent magnet 51 located on the front wall 12. These lines of magnetic force affect arcs and, in accordance with the Fleming's left-hand rule, the arc generated between the contact point 23a of the main contact side movable contact 23 and the contact point 21a of the one main contact side fixed contact 21 is driven in a leftward direction indicated by a solid line arrow B (hereinafter, referred to as a left arc). On the other hand, the arc generated between the contact point 23b of the main contact side movable contact 23 and the contact point 22a of the other main contact side fixed contact 22 is driven in a rightward direction indicated by a solid line arrow B (hereinafter, referred to as a right arc). Then, as illustrated in FIG. 8, the left arc collides with the left side wall of the arc-extinguishing chamber 10, extends in a downward direction as indicated by a solid arrow, returns to the main contact side movable contact 23 via the bottom wall of the left-side arc extension recess 16, then, is eventually extinguished. On the other hand, as illustrated in FIG. 8, the right arc collides with the right side wall of the arc-extinguishing chamber 10, extends in a downward direction as indicated by a solid arrow, returns to the main contact side movable contact 23 via the bottom wall of the right-side arc extension recess 16, then, is eventually extinguished. It should be noted that, when the left arc and the right arc respectively collide with the left side wall of the arc-extinguishing chamber 10 and the right side wall of the arc-extinguishing chamber 10, each arc is split into the front and back and the front one collides with the front wall 12 and the back one collides with the rear wall 13 as indicated by solid lines of FIG. 9 (only the flow of the right arc is illustrated in FIG. 9). Then, the left arc and the right arc extend in a downward direction as indicated by solid arrows, collide with the partitioning wall 11 of the arc-extinguishing chamber 10, extend toward the center and inside the arc extension recess 16, return to the main contact side movable contact 23, then, are extinguished.

Here, since each arc extension recess 16 is made by indenting the partitioning wall 11 that partitions the main contact mechanism housing chamber 25 and the auxiliary contact mechanism housing chamber 41 toward the side of the auxiliary contact mechanism housing chamber 41, the extension space for arcs can be enlarged without having to enlarge the size of the electromagnetic contactor 1 in the direction in which the main contact mechanism housing chamber 25 and the auxiliary contact mechanism housing chamber 41 are arranged (up and down direction). In this way, even a current that flows in the main contact mechanism 2 is large, arcs can be properly blocked.

The left-side arc extension recess 16 is formed near the contact point 23a of the main contact side movable contact 23 and the contact point 21a of the left-side main contact side fixed contact 21, while the right-side arc extension recess 16 is formed near the contact point 23b of the main contact side movable contact 23 and the contact point 22a of the right-side main contact side fixed contact 22. In this way, the left arc and right arc can be properly extended.

Further, a pair of arc-driving permanent magnets 51, 52 for driving arcs in the extension directions of the main contact side movable contact 23 (leftward and rightward directions) is oppositely arranged on the front wall 12 and rear wall 13 of the arc-extinguishing chamber 10. The lines of magnetic force are directed from the N pole of the arc-driving permanent magnet 52 located on the rear wall 13 to the S pole of the arc-driving permanent magnet 51 located on the front wall 12. As such, the left arc can be properly driven in a leftward direction toward the left-side arc extension recess 16 and the right arc can be properly driven in a rightward direction toward the right-side arc extension recess 16.

It should be noted that, when left-side and right-side arc extension recesses 16 are formed by indenting the partitioning wall 11 to the side of the auxiliary contact mechanism housing chamber 41, the space inside the auxiliary contact mechanism housing chamber 41 becomes smaller by the space of forming the arc extension recesses 16. This might possibly disable the auxiliary contact mechanism 4 to be housed in the auxiliary contact mechanism housing chamber 41.

To solve this problem, the auxiliary movable contact supporting member 43 is housed in a left and right direction in the auxiliary contact mechanism housing chamber 41 between the pair of arc extension recesses 16. Further, the plurality of auxiliary contact side movable contacts 49 extend in the same left and right direction as the main contact side movable contact 23 and are supported by the auxiliary movable contact supporting member 43. In addition, the auxiliary fixed contact supporting member 42 has four auxiliary fixed contact supporting parts 42a, 42b, 42c, 42d that are housed in the auxiliary contact mechanism housing chamber 41 at both front and rear sides of and between the pair of arc extension recesses 16 and that fix the plurality of pairs of auxiliary contact side fixed contacts 48. In this way, the auxiliary contact mechanism 4 can be properly housed in the auxiliary contact mechanism housing chamber 41 even though a pair of left-side and right-side arc extension recesses 16 is formed by indenting the partitioning wall 11 of the arc-extinguishing chamber 10 toward the side of the auxiliary contact mechanism housing chamber 41.

As described above, the left arc and right arc are extinguished and, when the release operation of the movable plunger 35 has completed, the opening completes.

### Second Embodiment

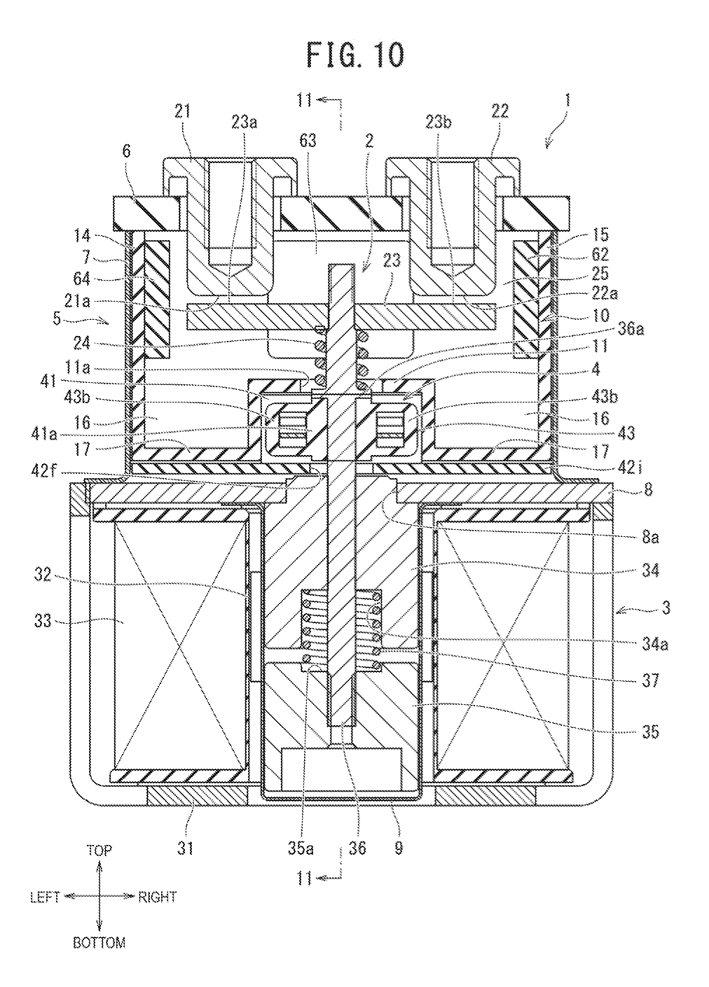

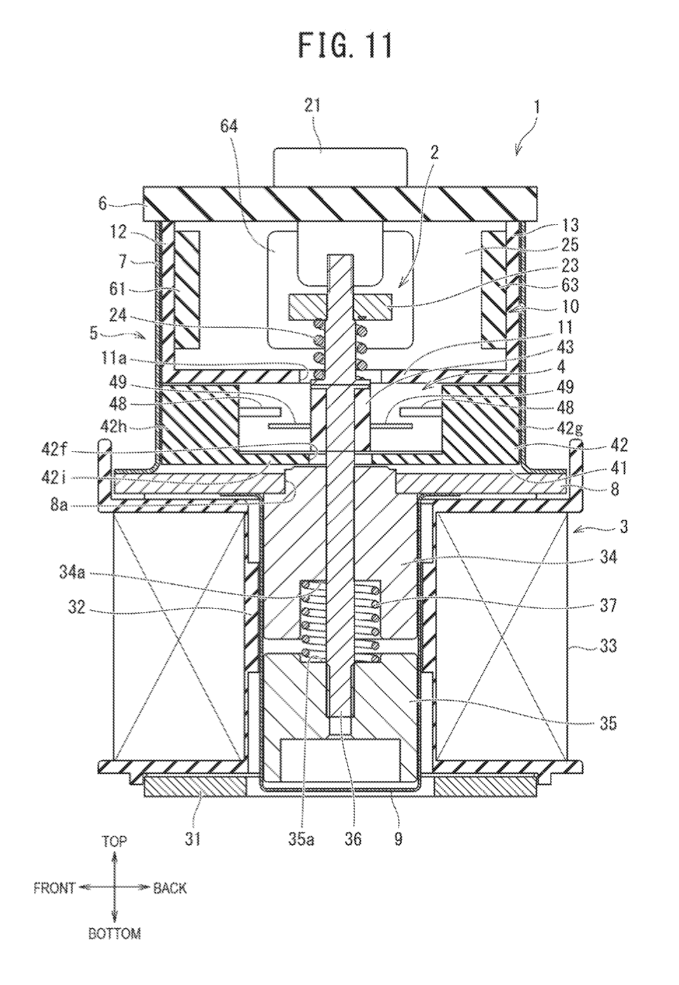

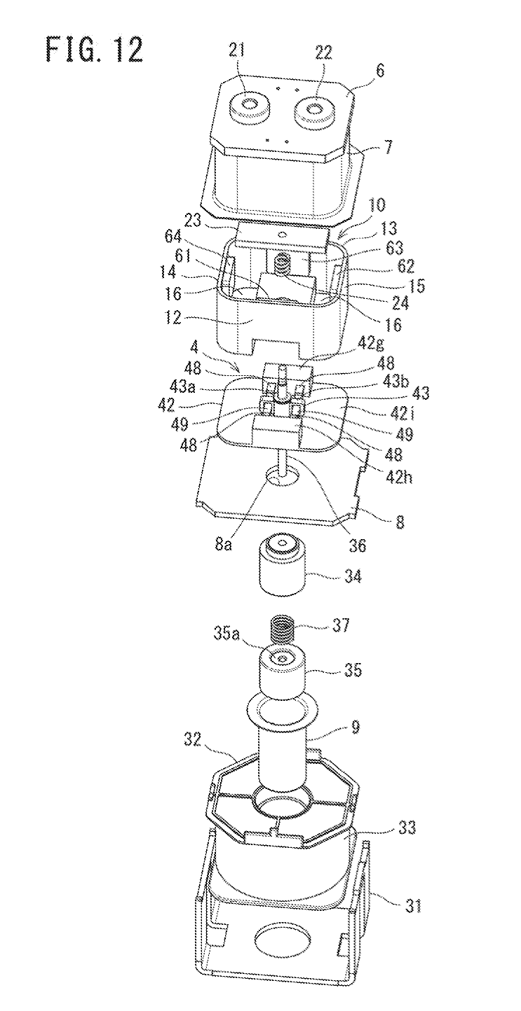

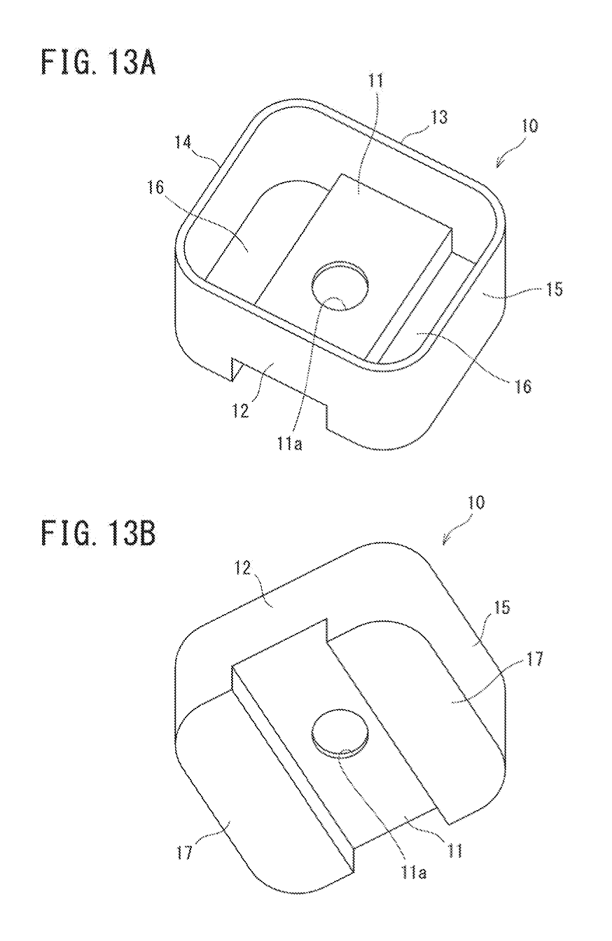

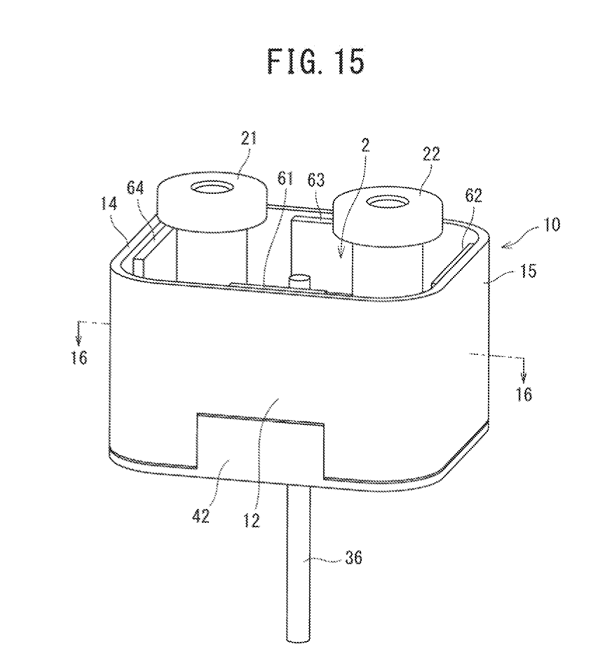

Next, an electromagnetic contactor according to a second embodiment of the present invention will be described with reference to FIGS. 10 to 21. In FIGS. 10 to 21, like components as those illustrated in FIGS. 1 to 9 are assigned the same signs and the explanation may be omitted.

The electromagnetic contactor according to the second embodiment of the present invention includes that same basic components as those of the electromagnetic contactor 1 according to the first embodiment illustrated in FIGS. 1 to 9, yet, is different in the shapes of the left-side and right-side arc extension recesses 16 and the shape of the auxiliary contact mechanism 4.

In particular, as illustrated in FIG. 10, the left-side arc extension recess 16 of the electromagnetic contactor 1 according to the second embodiment is formed near the contact point 23a of the main contact side movable contact 23 and the contact point 21a of the left-side main contact side fixed contact 21, specifically, below both contact points 23a, 21a, and extends in a left and right direction from a location in the vicinity of the contact point 23a up to the left side wall 14 of the arc-extinguishing chamber 10. On the other hand, as illustrated in FIG. 10, the right-side arc extension recess 16 is formed near the contact point 23b of the main contact side movable contact 23 and the contact point 22a of the right-side main contact side fixed contact 22, specifically, below both contact points 23b, 22a, and extends in a left and right direction from a location in the vicinity of the contact point 23b up to the right side wall 15 of the arc-extinguishing chamber 10. These features are the same as those of the left-side and right-side arc extension recesses 16 of the electromagnetic contactor 1 according to the first embodiment.

However, as illustrated in FIGS. 10 to 13B, the left-side arc extension recess 16 of the electromagnetic contactor 1 according to the second embodiment extends in a direction orthogonal to the extension directions of the main contact side movable contact 23. That is, the left-side arc extension recess 16 extends in a front and rear direction from the front wall 12 up to the rear wall 13 of the arc-extinguishing chamber 10. Likewise, the right-side arc extension recess 16 of the electromagnetic contactor 1 according to the second embodiment extends in a direction orthogonal to the extension direction of the main contact side movable contact 23. That is, the right-side arc extension recess 16 extends in a front and rear direction from the front wall 12 up to the rear wall 13 of the arc-extinguishing chamber 10.

In this way, by extending each of the left-side and right-side arc extension recesses 16 in a direction orthogonal to the extension direction of the main contact side movable contact 23, the driving direction of arcs can be the directions orthogonal to the extension direction of the main contact side movable contact 23 (frontward and backward directions) without limitation to the extension directions of the main contact side movable contact 23 (leftward and rightward directions) as in the first embodiment.

The following will describe driving and extinguishing of arcs in the electromagnetic contactor 1 according to the second embodiment.

First, two pairs of arc-driving permanent magnets 61, 62, 63, 64, for driving arcs to the extension directions (frontward and backward directions) of the pair of arc extension recesses 16, that is, into the pair of arc extension recesses 16, are respectively arranged on the front wall 12, the right side wall 15, the rear wall 13, and the left side wall 14 of the arc-extinguishing chamber 10 that houses the main contact mechanism 2, as illustrated in FIGS. 10 to 12, FIG. 15 and FIG. 16.

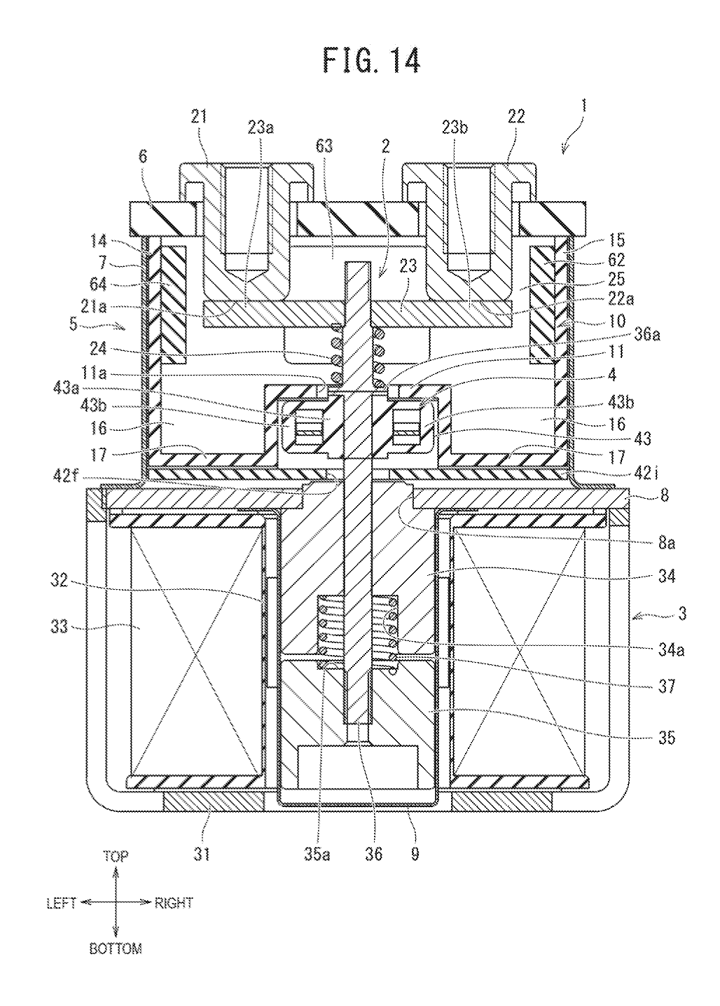

Then, when the main contact side movable contact 23 is shifted from an open state illustrated in FIG. 14 to an open start state where the main contact side movable contact 23 is downward apart from the pair of main contact side fixed contacts 21, 22, arcs are generated between both contact points 23a, 23b of the main contact side movable contact 23 and both contact points 21a, 22a of the pair of main contact side fixed contacts 21, 22, thus, an electricity conducting state is maintained by the arcs.

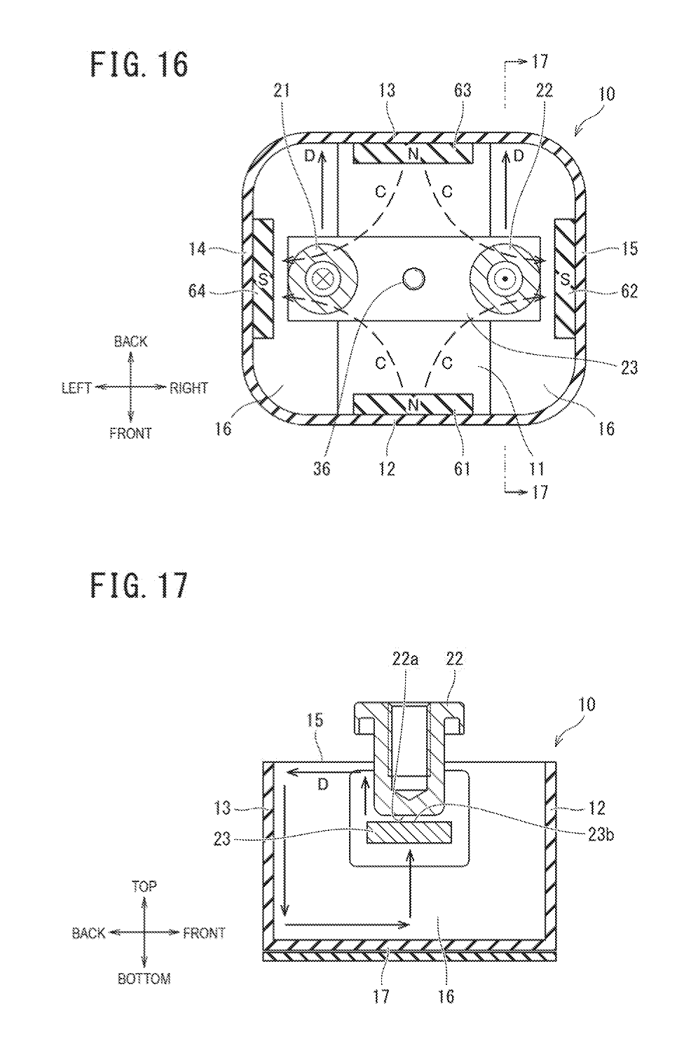

Here, as illustrated in FIG. 16, the lines of magnetic force indicated by dashed line arrows C are directed from the N pole of the arc-driving permanent magnet 61 located on the front wall 12 of the arc-extinguishing chamber 10 to the S pole of the arc-driving permanent magnet 64 located on the left side wall 14 and the S pole of the arc-driving permanent magnet 62 located on the right side wall 15. These lines of magnetic force affect arcs and, in accordance with the Fleming' s left-hand rule, the arc generated between the contact point 23a of the main contact side movable contact 23 and the contact point 21a of the one main contact side fixed contact 21 is driven in a backward direction indicated by a solid line arrow D (hereinafter, referred to as a left arc). On the other hand, the arc generated between the contact point 23b of the main contact side movable contact 23 and the contact point 22a of the other main contact side fixed contact 22 is driven in a backward direction indicated by a solid line arrow D (hereinafter, referred to as a right arc). Then, the left arc and right arc collide with the rear wall 13 of the arc-extinguishing chamber 10 and extend in a downward direction along the rear wall 13 as illustrated by a solid line of FIG. 17 (only the flow of the right arc is illustrated in FIG. 17). Then, the left arc and the right arc respectively collide with the bottom wall of the left-side arc extension recess 16 and the bottom wall of the right-side arc extension recess 16, extend in a forward direction, return, at the central part in a front and rear direction, to the main contact side movable contact 23, then, are extinguished.

Here, since the left-side and right-side arc extension recesses 16 are made by indenting the partitioning wall 11 that partitions the main contact mechanism housing chamber 25 and the auxiliary contact mechanism housing chamber 41 toward the side of the auxiliary contact mechanism housing chamber 41, the extension space for arcs can be enlarged without having to enlarge the size of the electromagnetic contactor 1 in the direction in which the main contact mechanism housing chamber 25 and the auxiliary contact mechanism housing chamber 41 are arranged (up and down direction). In this way, even a current that flows in the main contact mechanism 2 is large, arcs can be properly blocked.

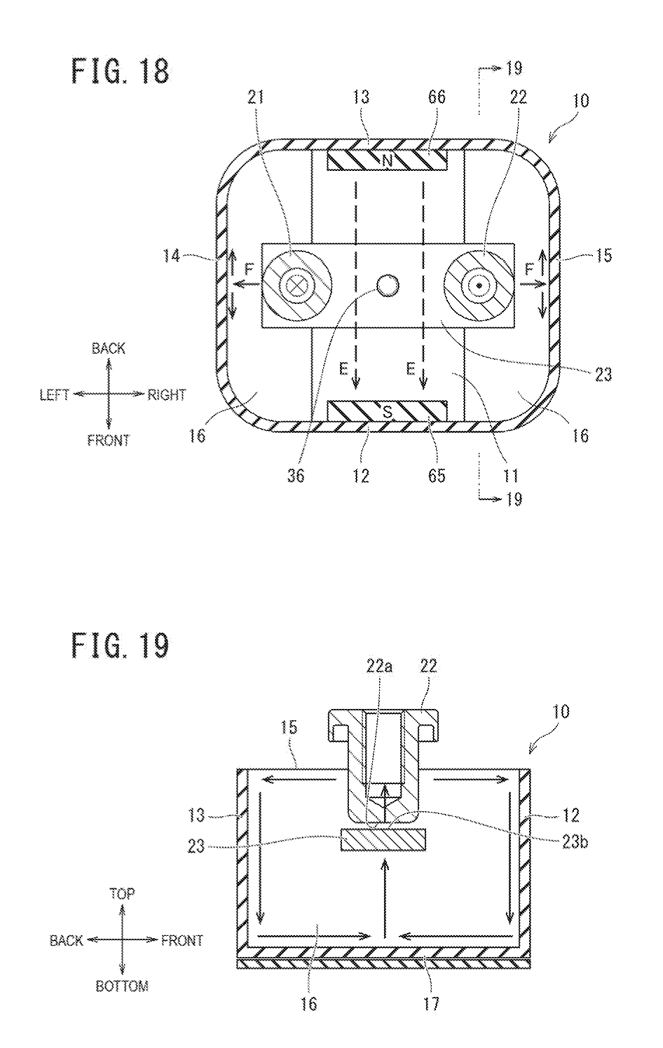

Next, with the electromagnetic contactor 1 according to the second embodiment, as illustrated in FIG. 18, a pair of arc-driving permanent magnets 65, 66 for driving arcs to the extension directions (leftward direction and rightward direction) of the main contact side movable contact 23, that is, into the pair of arc extension recesses 16, can be arranged oppositely on the front wall 12 and rear wall 13 of the arc-extinguishing chamber 10 that houses the main contact mechanism 2.

In this case, the lines of magnetic force are directed in a direction indicated by dashed line arrows E from the N pole of the arc-driving permanent magnet 66 located on the rear wall 13 of the arc-extinguishing chamber 10 to the S pole of the arc-driving permanent magnet 65 located on the front wall 12. These lines of magnetic force affect arcs and, in accordance with the Fleming's left-hand rule, the arc generated between the contact point 23a of the main contact side movable contact 23 and the contact point 21a of the one main contact side fixed contact 21 is driven in a leftward direction indicated by a solid line arrow F (hereinafter, referred to as a left arc). On the other hand, the arc generated between the contact point 23b of the main contact side movable contact 23 and the contact point 22a of the other main contact side fixed contact 22 is driven in a rightward direction indicated by a solid line arrow F (hereinafter, referred to as a right arc). Then, when the left arc and the right arc respectively collide with the left side wall 14 of the arc-extinguishing chamber 10 and the right side wall 15 of the arc-extinguishing chamber 10, each arc is split into the front and back and the front one collides with the front wall 12 and the back one collides with the rear wall 13 as indicated by solid lines of FIG. 19 (only the flow of the right arc is illustrated in FIG. 19). The left arc and right arc subsequently extend in a downward direction as indicated by solid line arrows, collide with the bottom wall of the left-side arc extension recess 16 and the bottom wall of the right-side arc extension recess 16 respectively, then, extend to the center. Then, the arcs return to the main contact side movable contact 23 and are extinguished.

Here, since the left-side and right-side arc extension recesses 16 are made by indenting the partitioning wall 11 that partitions the main contact mechanism housing chamber 25 and the auxiliary contact mechanism housing chamber 41 toward the side of the auxiliary contact mechanism housing chamber 41, the extension space for arcs can be enlarged without having to enlarge the size of the electromagnetic contactor 1 in the direction in which the main contact mechanism housing chamber 25 and the auxiliary contact mechanism housing chamber 41 are arranged (up and down direction). In this way, even a current that flows in the main contact mechanism 2 is large, arcs can be properly blocked.

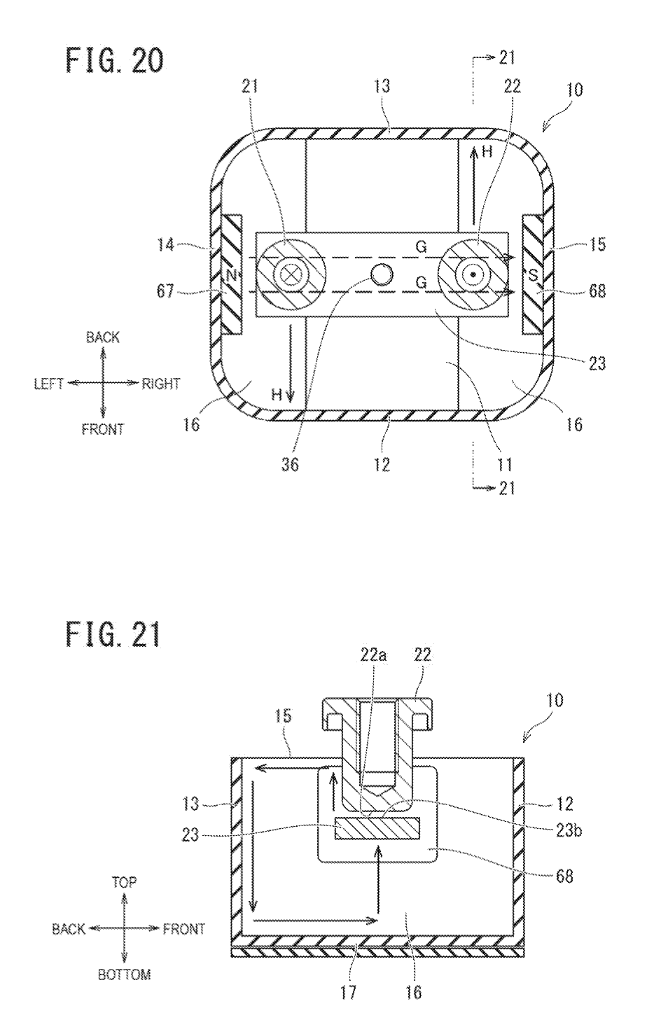

Further, as illustrated in FIG. 20, in the electromagnetic contactor 1 according to the second embodiment, a pair of arc-driving permanent magnets 67, 68, for driving the left arc to one extension direction (frontward direction) of the arc extension recess 16 and driving the right arc to the other extension direction (backward direction) of the arc extension recess 16, can be arranged oppositely on the left side wall 14 and right side wall 15 of the arc-extinguishing chamber 10 that houses the main contact mechanism 2.

In this case, the lines of magnetic force are directed in a direction indicated by dashed line arrows G from the N pole of the arc-driving permanent magnet 67 located on the left side wall 14 of the arc-extinguishing chamber 10 to the S pole of the arc-driving permanent magnet 68 located on the right side wall 15. These lines of magnetic force affect the arcs and, in accordance with the Fleming' s left-hand rule, the left arc generated between the contact point 23a of the main contact side movable contact 23 and the contact point 21a of the one main contact side fixed contact 21 is driven in a frontward direction indicated by a solid line arrow H. On the other hand, the right arc generated between the contact point 23b of the main contact side movable contact 23 and the contact point 22a of the other main contact side fixed contact 22 is driven in a backward direction indicated by a solid line arrow H. Then, the left arc collides with the front wall 12 of the arc-extinguishing chamber 10, extends in a downward direction and collides with the bottom wall of the left-side arc extension recess 16, extends in a backward direction along the bottom wall, and returns from the central part in a front and rear direction to the main contact side movable contact 23. The arc is, then, extinguished. On the other hand, the right arc collides with the rear wall 13 of the arc-extinguishing chamber 10, extends in a downward direction and collides with the bottom wall of the right-side arc extension recess 16, extends in a forward direction along the bottom wall, and returns from the central part in a front and rear direction to the main contact side movable contact 23. The arc is, then, extinguished.

Here, since the left-side and right-side arc extension recesses 16 are made by indenting the partitioning wall 11 that partitions the main contact mechanism housing chamber 25 and the auxiliary contact mechanism housing chamber 41 toward the side of the auxiliary contact mechanism housing chamber 41, the extension space for arcs can be enlarged without having to enlarge the size of the electromagnetic contactor 1 in the direction in which the main contact mechanism housing chamber 25 and the auxiliary contact mechanism housing chamber 41 are arranged (up and down direction). In this way, even a current that flows in the main contact mechanism 2 is large, arcs can be properly blocked.

As described above, according to the electromagnetic contactor 1 of the second embodiment, each of the left-side and right-side arc extension recesses 16 extends in a direction orthogonal to the extension direction of the main contact side movable contact 23. That is, each arc extension recess 16 extends in a front and rear direction from the front wall 12 up to the rear wall 13 of the arc-extinguishing chamber 10. In this way, the driving directions of arcs may be directions orthogonal to the extension direction of the main contact side movable contact 23 (frontward and backward directions) without limiting to the extension directions of the main contact side movable contact 23 (leftward direction and rightward direction).

Next, if the left-side and right-side arc extension recesses 16 are extended from the front wall 12 up to the rear wall 13 of the arc-extinguishing chamber 10 in a front and rear direction, the space within the auxiliary contact mechanism housing chamber 41 becomes smaller by the space of forming the arc extension recesses 16. This might possibly disable the auxiliary contact mechanism 4 to be housed in the auxiliary contact mechanism housing chamber 41.

To solve this problem, as illustrated in FIGS. 10 to 12, in the electromagnetic contactor 1 according to the second embodiment, the auxiliary movable contact supporting member 43 is housed in the auxiliary contact mechanism housing chamber 41 between the pair of arc extension recesses 16 in a left and right direction. Further, a plurality of (two in the second embodiment) auxiliary contact side movable contacts 49 extend in a front and rear direction orthogonal to the main contact side movable contact 23 and are supported by the auxiliary movable contact supporting member 43. In addition, the auxiliary fixed contact supporting member 42 has two auxiliary fixed contact supporting parts 42g, 42h that are housed in a left and right direction in the auxiliary contact mechanism housing chamber 41 between the pair of arc extension recesses 16 and are housed in a front and rear direction at the front and rear of the auxiliary movable contact supporting member 43. Each auxiliary fixed contact supporting part 42g, 42h fixes two auxiliary contact side fixed contacts 48, 48 and are arranged on a bottom plate 42i of a generally rectangular flat plate shape. The bottom plate 42i has a through hole 42f at its center portion, through which the connecting shaft 36 can be inserted. As such, the auxiliary contact mechanism 4 can be properly housed in the auxiliary contact mechanism housing chamber 41, even though a pair of left-side and right-side arc extension recesses 16 is formed by indenting the partitioning wall 11 of the arc-extinguishing chamber 10 toward the side of the auxiliary contact mechanism housing chamber 41 and further extending each arc extension recess 16 in a front and rear direction from the front wall 12 to the rear wall 13 of the arc-extinguishing chamber 10. In this case, the auxiliary contact side fixed contacts 48 fixed by the auxiliary fixed contact supporting part 42g and the auxiliary contact side fixed contacts 48 fixed by the auxiliary fixed contact supporting part 42h are electrically conducted via the auxiliary contact side movable contacts 49.

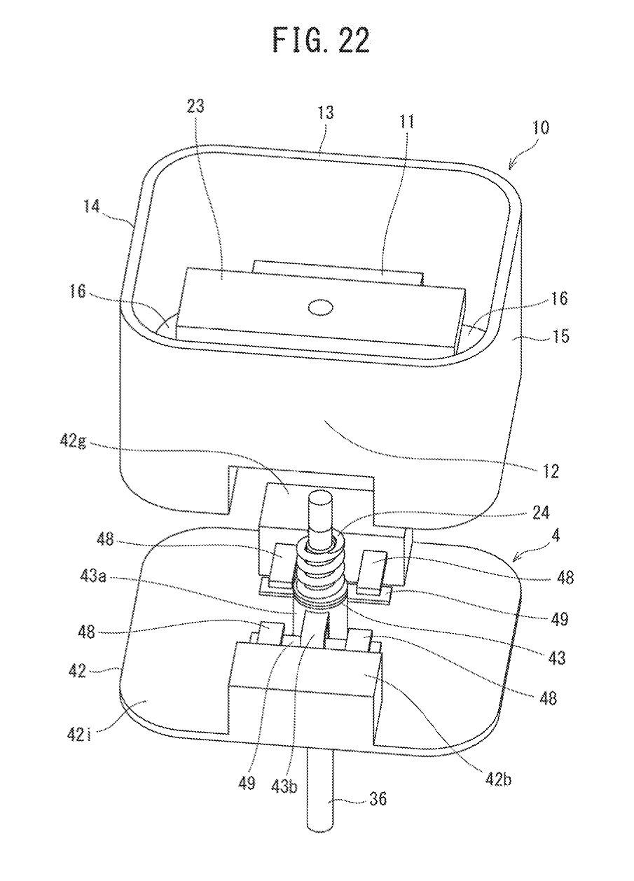

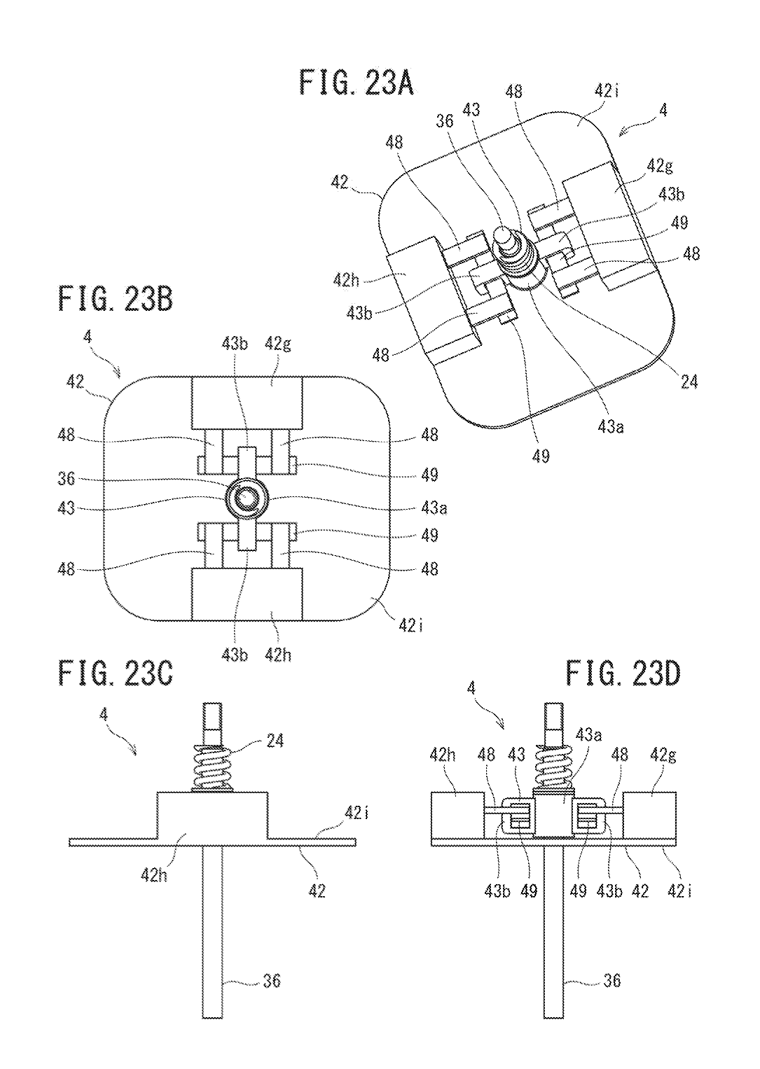

It should be noted that, as illustrated in FIGS. 22 to 23D, the plurality of auxiliary contact side movable contacts 49 may be extended in the same left and right direction as the main contact side movable contact 23 by rotating an auxiliary movable contact supporting member 43 supporting a plurality of (two in the second embodiment) auxiliary contact side movable contacts 49 by 90 degrees around the connecting shaft 36. In this case, the two auxiliary contact side fixed contacts 48 fixed by the auxiliary fixed contact supporting part 42g are electrically conducted via the auxiliary contact side movable contact 49, as well as, the two auxiliary contact side fixed contacts 48 fixed by the auxiliary fixed contact supporting part 42h are electrically conducted by the other auxiliary contact side movable contact 49.

As illustrated in FIGS. 22 to 23D, it should be appreciated that the auxiliary contact mechanism 4 can also be properly housed in the auxiliary contact mechanism housing chamber 41 even though the auxiliary movable contact supporting member 43 is rotated by 90 degrees around the connecting shaft 36 to make the plurality of auxiliary contact side movable contacts 49 extended in the same left and right direction as the main contact side movable contact 23.

Although the above has described embodiments of the present invention, the present invention can be modified and improved in many ways without limitation to these embodiments.

For example, in the electromagnetic contactor 1 according to the first embodiment and the electromagnetic contactor 1 according to the second embodiment, each main contact side fixed contact 21, 22 is formed in a column shape protruding in the arc-extinguishing chamber 10. However, each main contact side fixed contact 21, 22 may be formed in a U-shaped section in the arc-extinguishing chamber 10, and the main contact side movable contact 23 may be in contact with the main contact side fixed contacts 21, 22 of the U-shaped section.

Further, the electromagnetic contactor 1 according to the first and the second embodiments may be laid down so that the main contact mechanism 2, the auxiliary contact mechanism 4, and the electromagnet unit 3 are arranged side by side and oriented in a horizontal direction.

As long as the auxiliary contact mechanism 4 is housed in the auxiliary contact mechanism housing chamber 41, the structure is not limited to the illustration for both electromagnetic contactor 1 according to the first embodiment and electromagnetic contactor 1 according to the second embodiment.

In the electromagnetic contactor 1 according to the first embodiment, the number of the pairs of the arc-driving permanent magnets 51, 52 configured to drive arcs in the extension directions of the main contact side movable contact 23 is at least one without limiting to one.

Further, in the electromagnetic contactor 1 according to the second embodiment, the arrangement and pole faces of the arc-driving permanent magnets are not limited to those illustrated in the figures, as long as the arcs are driven in the extension directions of the main contact side movable contact 23 or the extension directions of the pair of arc extension recesses 16, that is, into the pair of arc extension recesses 16.

### REFERENCE SIGNS LIST

1 Electromagnetic contactor
2 Main contact mechanism
3 Electromagnet unit
4 Auxiliary contact mechanism
5 Housing chamber
10 Arc-extinguishing chamber
11 Partitioning wall
12 Front wall
13 Rear wall
14 Left Side wall
15 Right side wall
16 Arc extension recess
21, 22 Main contact side fixed contact
23 Main contact side movable contact
23a, 23b Contact point
25 Main contact mechanism housing chamber
35 Movable plunger
36 Connecting shaft
41 Auxiliary contact mechanism housing chamber
42 Auxiliary fixed contact supporting member
42a, 42b, 42c, 42d Auxiliary fixed contact supporting part
42g, 42h Auxiliary fixed contact supporting part
43 Auxiliary movable contact supporting member
48 Auxiliary contact side fixed contact
49 Auxiliary contact side movable contact
51, 52 Arc-driving permanent magnet
61, 62 63, 64 Arc-driving permanent magnet
65, 66 Arc-driving permanent magnet
67, 68 Arc-driving permanent magnet

1. An electromagnetic contactor comprising:
a main contact mechanism housing chamber for housing a main contact mechanism, the main contact mechanism including a pair of main contact side fixed contacts with a predetermined interspace, and a main contact side movable contact configured to move toward and away from the pair of main contact side fixed contacts;
an auxiliary contact mechanism housing chamber for housing an auxiliary contact mechanism, the auxiliary contact mechanism including at least a pair of auxiliary contact side fixed contacts that is fixed to an auxiliary fixed contact supporting member, and an auxiliary contact side movable contact configured to move toward and away from the at least pair of auxiliary contact side fixed contacts;
an electromagnet unit including a movable plunger for driving the main contact side movable contact and the auxiliary contact side movable contact; and
a partitioning wall for partitioning the main contact mechanism housing chamber and the auxiliary contact mechanism housing chamber,
wherein the partitioning wall has a pair of arc extension recesses that is formed by indenting the partitioning wall toward the side of the auxiliary contact mechanism housing chamber and into which an arc generated by the main contact mechanism extends.

2. The electromagnetic contactor according to claim 1, wherein the pair of arc extension recesses is formed near contact points of the main contact side movable contact and the main contact side fixed contacts.

3. The electromagnetic contactor according to claim 2, wherein at least a pair of arc-driving permanent magnets, for driving the arc in extension directions of the main contact side movable contact, is arranged on walls of the main contact mechanism housing chamber.

4. The electromagnetic contactor according to claim 1, wherein the pair of arc extension recesses is formed near contact points of the main contact side movable contact and the main contact side fixed contacts and extend in directions orthogonal to an extension direction of the main contact side movable contact.

5. The electromagnetic contactor according to claim 4, wherein at least a pair of arc-driving permanent magnets, for driving the arc into the pair of arc extension recesses, is arranged on walls of the main contact mechanism housing chamber.
